(19) United States
(12) Patent Application Publication
(10) Pub. No.: US 2008/0036722 A1
(43) Pub. Date: Feb. 14, 2008

(54) SCANNING LINE DRIVE CIRCUIT FOR DISPLAY DEVICE

(75) Inventors: Seiichi URAMOTO, Fukaya-shi (JP); Tetsuo MORITA, Kounosu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/781,542

(22) Filed: Jul. 23, 2007

(30) Foreign Application Priority Data
Aug. 9, 2006 (JP) 2006-217097

(51) Int. Cl. G09G 3/36

(52) U.S. Cl. 345/98

(57) ABSTRACT

To effectively perform an MF drive by using a simple configuration, a scanning line drive circuit for a display device includes scanning-line driving shift registers serially disposed at a plurality of stages; first switch elements each connected between an output terminal of a first one of the scanning-line driving shift registers and an input terminal of a second scanning-line driving shift register disposed at the following stage; second switch elements each connected between the output terminal of a first one of the scanning-line driving shift registers and the input terminal of a third scanning-line driving shift register disposed at the N+1-th stage following the first scanning-line driving shift register; and a control circuit which controls the first switch elements and the second switch elements.

### CROSS-REFERENCE TO RELATED APPLICATIONS

This application is based upon and claims the benefit of priority from Japanese Patent Application No. 2006-217097 filed Aug. 9, 2006; the entire contents of which are incorporated herein by reference.

### BACKGROUND OF THE INVENTION

1. Field of the Invention

The present invention relates to a scanning line drive circuit for a display device.

2. Description of the Related Art

Two of the main scan modes for a television image and the like are a non-interlaced mode (a progressive scan mode) and an interlaced mode.

The non-interlaced mode is a mode in which lines composing one screen (a frame) are scanned in sequence from the uppermost line, and the mode allows a display to be clearer, and to flicker less than a display in the interlaced mode. In the following description, a “normal drive” refers to a drive method for sequentially and successively driving a plurality of scanning lines, which are connected to a scanning line drive circuit, by using a frequency (for example, 60 Hz) for non-interlace drive in order to achieve the non-interlace mode (the progressive scan mode).

The interlaced mode is a mode in which lines composing one frame are divided and scanned several times. When performance is low, use of the non-interlaced mode causes a screen to flicker due to a time difference between the first scanning and the last scanning. With the interlaced mode, for example, a certain frame is displayed by dividing the certain frame into a group of odd-number rows and a group of even-number rows, and then by alternately displaying the two groups of rows. Thereby, the flicker in the displayed frame can be eliminated. In the following description, a “multi-field (MF) drive” refers to a drive method for driving every N-th line among a plurality of scanning lines, which are connected to a scanning line drive circuit (hereinafter Ndenotes a positive integer which is 1 or greater), by using a frequency for interlace drive in order to achieve the interlace mode. Incidentally, since one frame is divided and then displayed with the MF drive, a driving frequency can be set lower than that for the normal drive by the number of divisions in a display, and power consumption can be further suppressed.

Note that techniques for driving scanning lines have been disclosed, for example, in JP-A No. Hei 3-271795, JP-A No. Hei 5-323903, and JP-A No. 2005-227757.

However, the MF drive causes not only a shift register for driving a scanning line of a driving target, but also that for driving a scanning line which is not a driving target, to be driven. This leads to a problem of wasting power and time for driving the shift register for driving a scanning line which is not a drive target.

When the MF drive is performed, it is necessary to add logic circuits of the number equal to that of the N scanning lines in order to scan every N-th line of the scanning line. This causes problems that a configuration of a scanning line drive circuit becomes complicated, and that an area occupied by the scanning-line driving circuit on a substrate of a display device is increased.

### SUMMARY OF THE INVENTION

An object of the present invention is to achieve an effective MF drive by using a simple configuration, in a scanning line drive circuit for a display device.

A first scanning line drive circuit for a display device in the present invention includes scanning-line driving shift registers which are serially disposed at a plurality of stages, and each of which outputs a scanning line signal to a corresponding scanning line connected to an output terminal in response to a signal inputted through an input terminal; first switch elements each connected between an output terminal of a first one of the scanning-line driving shift registers and an input terminal of a second scanning-line driving shift register disposed at a stage following the current scanning-line driving shift register; second switch elements each connected between the output terminal of a first one of the scanning-line driving shift registers and the input terminal of a third scanning-line driving shift register disposed at the N+1-th stage following the first scanning-line driving shift register (N being a positive integer equal to or greater than 1); and a control circuit which controls the first switch elements and the second switch elements.

A second scanning line drive circuit for a display device includes scanning-line driving shift registers which are serially disposed on a plurality of stages, and each of which outputs a scanning line signal to a corresponding scanning line connected to an output terminal, in response to a signal inputted through an input terminal; first switch elements each connected between the output terminal of a first one of the scanning-line driving shift registers and the input terminal of a second scanning-line driving shift register disposed at a stage following the first scanning-line driving shift register; second switch elements each connected between the output terminal of a first one of the scanning-line driving shift registers and the input terminal of a second scanning-line driving shift register disposed at the N+1 stage following the first scanning-line driving shift register (N being a positive integer equal to or greater than 1); a signal line through which a predetermined electric signal is transmitted; third switch elements each connected to the signal lines and to the input terminal of a corresponding one of the scanning-line driving shift registers; and a control circuit which controls the first switch elements, the second switch elements and the third switch elements.

### BRIEF DESCRIPTION OF THE DRAWINGS

FIG. 1 is a structural view showing a structure of a liquid crystal display device;

FIG. 2 is a circuit diagram showing one example of a circuit configuration of a liquid crystal display device of an active matrix drive type;

FIG. 3 is a circuit diagram showing a basic configuration of a liquid crystal display panel;

FIG. 4 is a circuit diagram showing a configuration of a scanning line drive circuit of a first embodiment;

FIG. 5 is a view showing an operation of an MF drive in which scanning-line driving shift registers are caused to operate at every other stage;

FIG. 6 is a view showing an operation of an MF drive in which scanning-line driving shift registers corresponding to even-number stages and odd-number stages are caused to operate;

FIG. 7 is a circuit configuration diagram showing a configuration of a scanning line drive circuit of a comparative example; and

FIG. 8 is a circuit diagram showing a configuration of a scanning line drive circuit of a second embodiment.

### DESCRIPTION OF THE EMBODIMENT

### First Embodiment

A first embodiment of the present invention is described below with reference to the accompanying drawings.

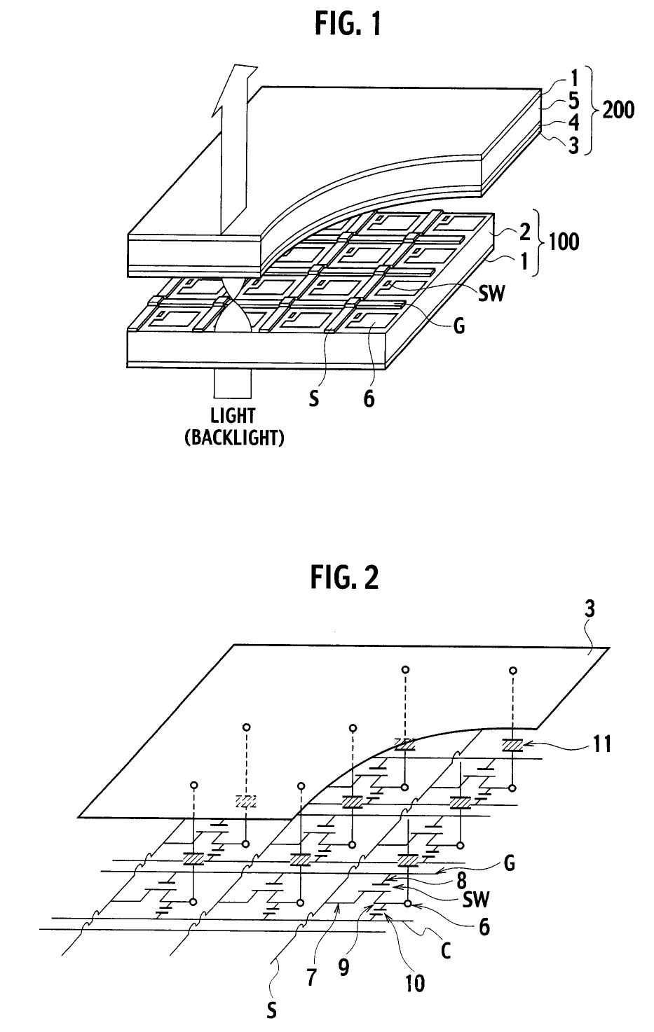

First, a configuration and an operation of a liquid crystal display device are briefly described. FIG. 1 is a structural view showing a structure of a liquid crystal display device of an active matrix drive type. Liquid crystals (not shown) are maintained between an array substrate 100 and a counter substrate 200 facing each other. A backlight (not shown) is disposed on the back surface of the array substrate 100. On the array substrate 100, a polarizing plate 1 and a glass substrate 2 are disposed in order from a position far from the liquid crystals. On the counter substrate 200, a counter electrode 3, a color filter 4, a glass substrate 5 and the polarizing plate 1 are disposed in order from a position close to the liquid crystals. On an upper part of the glass substrate 2, a plurality of picture signal lines S and a plurality of scanning lines G are disposed in matrix. MOS-type picture element transistors SW and display electrodes 6 are disposed at intersecting parts of each picture signal line S and each scanning line G.

Next, a description will be given of a configuration of a circuit formed on the glass substrate 2 of the liquid crystal display device shown in FIG. 1. FIG. 2 is a circuit diagram showing one example of a circuit configuration of a liquid crystal display device of the active matrix drive type. A source electrode 7 of the picture element transistor SW is connected to the relevant picture element signal line S, and a gate electrode 8 is connected to the relevant scanning line G. A display electrode 6 and a storage capacitor 10 are connected to a drain electrode 9 of the picture element transistor SW. Liquid crystals 11 are held between the display electrode 6 and the counter electrode 3. The other terminal of the storage capacitor 10, which is not connected to the drain electrode 9, is connected to a common capacitor line C wired in parallel to the scanning line G. The picture element transistor SW, the display electrode 6 and the storage capacitor 10 form each of picture elements (display dots) on a screen of the liquid crystal display device.

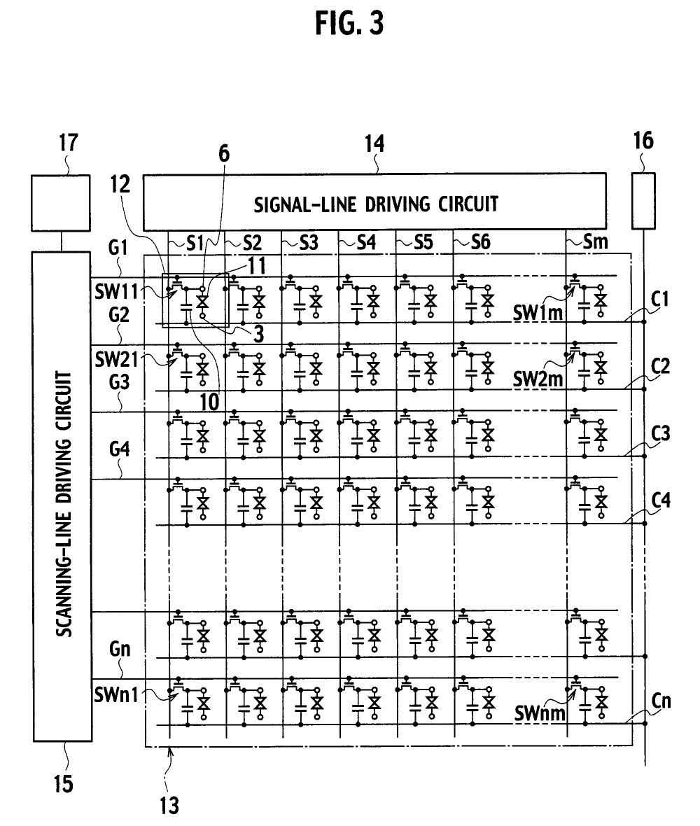

Subsequently, a description will be given of an entire configuration of a liquid crystal display panel having a circuit configuration of a liquid crystal display device shown in FIG. 2. FIG. 3 is a circuit diagram showing a basic configuration of a liquid crystal display panel. The picture elements (display dots) 12, which are described with FIG. 2, are arranged at each of intersecting points of n×m matrix wiring in a screen portion 13 of the liquid crystal display. Here, the n×m matrix wiring is composed of n rows of scanning lines G1 to Gn and m columns of picture signal lines S1 to Sm. The picture signal lines S1 to Sm are connected to a signal-line driving circuit 14; the scanning lines G1 to Gn are connected to a scanning-line driving circuit 15; and the common capacitor lines C1 to Cn are connected to a capacitor line drive circuit 16. The scanning-line driving circuit 15 is connected to an LCD controller 17.

Incidentally, the picture signal lines S1 to Sm, the scanning lines G1 to Gn, the common capacitor lines C1 to Cn, the picture element transistors SW, the display electrodes 6 and the storage capacitor 10 are formed at an upper part of the insulating glass substrate 2. The signal-line driving circuit 14, the scanning-line driving circuit 15, the capacitor line drive circuit 16, and the LCD controller 17 are also disposed at the upper part of the same glass substrate 2.

Next, a description will be given of a principle of an operation of a liquid crystal display device of an active matrix type is described with reference to FIGS. 1 to 3. A liquid crystal display device of a dot matrix of n×m arrangement is driven with a line-sequential drive in which picture data signals simultaneously supplied to the picture signal lines S1 to Sm are sampled by using scanning line signals sequentially supplied to the respective scanning lines G1 to Gn.

In a case where a certain time (T1 to Tn) is allocated to each scanning line G, application of a scanning line signal to the scanning line G1 at a selected time T1, all picture element transistors SW11 to SW1m disposed on the scanning line G1, thus causing a switch to be turned on. As a result, the picture data signals transmitted to the picture signal lines S1 to Sm are transmitted to the respective display electrodes 6 via the respective picture element transistors SW11 to SW1m, and are also supplied to the storage capacitors 10. Consequently, a voltage difference occurs between the display electrode 6 and the counter electrode 3, and thereby the orientations of liquid crystal molecules of the liquid crystals 11 are controlled. Thus, the brightness of incident light of the backlight shown in FIG. 1 is controlled, and thereby a color display according to a picture data signal is made possible by using a color filter 4.

At the next selected time T2, all of the picture element transistors SW11 to SW1m of the scanning line G1 are turned off, and thereby picture elements which have been selected by the scanning line G1 are electrically disconnected from the picture element signal lines S1 to Sm. At this time, a picture displayed at the selected time T1 is held by the storage capacitor 10 until the next scanning line signal is applied to the scanning line G1. Meanwhile, all picture element transistors SW21 to SW2m disposed on the scanning line G2 are turned on. As a result, picture element data signals are transmitted to the display electrodes 6, and are also supplied to the storage capacitors 10. One frame is displayed by repeating the same operation in the subsequent processes.

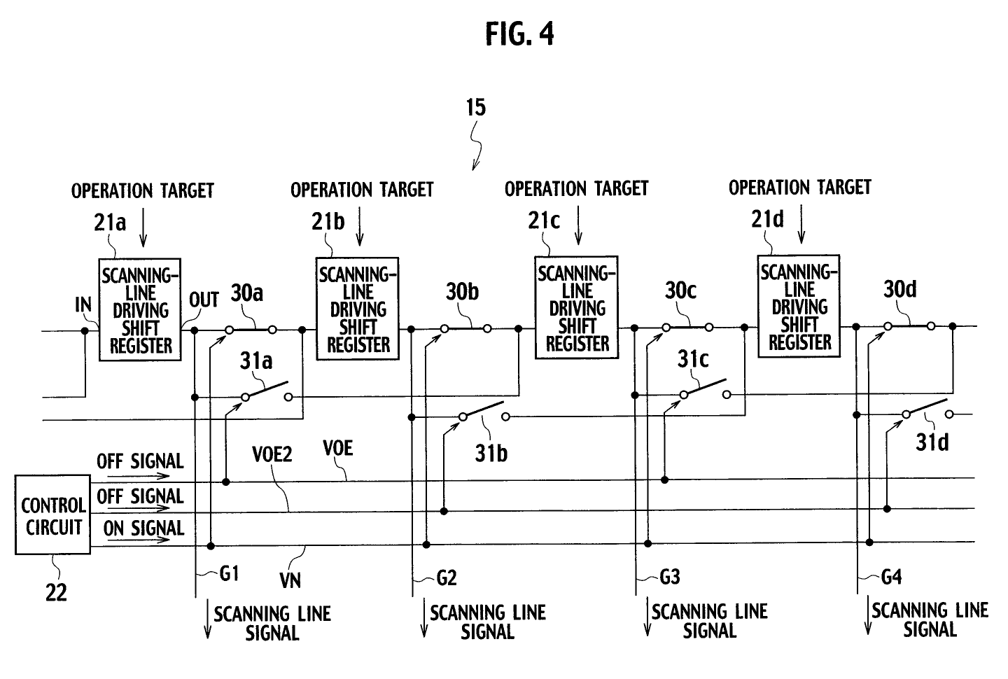

Next, a configuration of the scanning-line driving circuit 15 of the present embodiment will be described. FIG. 4 is a circuit diagram showing a configuration of the scanning-line driving circuit 15 of the present embodiment. The scanning-line driving circuit 15 includes scanning-line driving shift registers 21a to 21d disposed serially at a plurality of stages; first switch elements 30a to 30d; second switch elements 31a to 31d; a control signal line VN connected to the first switch elements 30a to 30d; a control signal line VOE connected to the second switch elements 31a and 31c corresponding to every other switch element; a control signal line VOE2 connected to the second switch elements 31b and 31d disposed every other switch element; and a control circuit 22 connected to the control signal lines VN, VOE and VOE2.

The scanning-line driving shift registers 21a to 21d output scanning line signals to scanning lines connected to output terminals OUT in response to signals (shift register start signals or shift register output signals) inputted to input terminals IN. The first switch elements 30a to 30d are connected between the output terminals OUT of the respective scanning-line driving shift registers 21a to 21d, and the input terminals IN of the respective shift registers 21b to 21e which are disposed at a stage following the scanning-line driving shift registers 21a to 21d. The second switch elements 31a to 31d are connected between the output terminals OUT of the respective scanning-line driving shift registers 21a to 21d, and the input terminals IN of the scanning line shift registers 21c to 21f which are disposed two stages (N+1 stages where N=1) behind the scanning-line driving shift registers 21a to 21d.

Incidentally, it is possible to include the control circuit 22, for example, in the LCD controller 17 shown in FIG. 3.

First, a description will be given of an operation of the normal drive in which all of the scanning-line driving shift registers are caused to be driven. The control circuit 22 transmits an ON signal to the control signal line VN before a shift register start signal is transmitted to the scanning-line driving shift register 21a. Consequently, the control circuit 22 turns on the first switch elements 30a to 30d connected to the output terminals OUT of all the scanning-line driving shift registers 21a to 21d which are operation targets. Meanwhile, the control circuit 22 transmits OFF signals to the respective control signal lines VOE and VOE2, and the second switch elements 31a to 31d are set to be OFF.

Subsequently, the scanning-line driving shift register 21a receives a transmitted shift register start signal through the input terminal IN, and then outputs a shift register output signal through the output terminal OUT. The thus outputted shift register output signal is transmitted, as a scanning line signal, to the scanning line G1 connected to the output terminal OUT, and is also transmitted to the following scanning-line driving shift register 21b via the first switch element 30a which is set to be ON. Incidentally, since the second switch element 31a has been set to be OFF, the shift register output signal outputted from the scanning-line driving shift register 21a is not transmitted to the scanning-line driving shift register 21c via the second switch element 31a.

Then, the scanning-line driving shift register 21b receives, as an input signal, the shift register output signal transmitted from the scanning-line driving shift register 21a through the input terminal IN, and then outputs a shift register output signal through the output terminal OUT. The thus outputted shift register output signal is transmitted, as a scanning line signal, to the scanning line G2 connected the output terminal OUT, and is also transmitted to the following scanning-line driving shift register 21c via the first switch 30b which has been set to be ON. Incidentally, since the second switch element 31b is OFF, the shift register output signal outputted from the scanning-line driving shift register 21b is not transmitted to the scanning-line driving shift register 21d via the second switch element 31b.

Hence, the scanning-line driving circuit 15 sequentially transmits the shift register start signal or the shift register output signal to the scanning-line driving shift registers in the order of 21a, 21b, 21c, 21d . . . , and then sequentially outputs the scanning line signal to the scanning lines in the order of G1, G2, G3, G4 . . . Accordingly, the scanning-line driving circuit 15 achieves the normal drive in which all of the scanning-line driving shift registers are caused to operate.

In the normal drive of the present embodiment, all of the first switch elements 30a to 30d are controlled to be ON, and all of the second switch elements 31a to 31d are controlled to be OFF. Thus, the present embodiment makes it possible to easily perform the normal drive by controlling the switch elements.

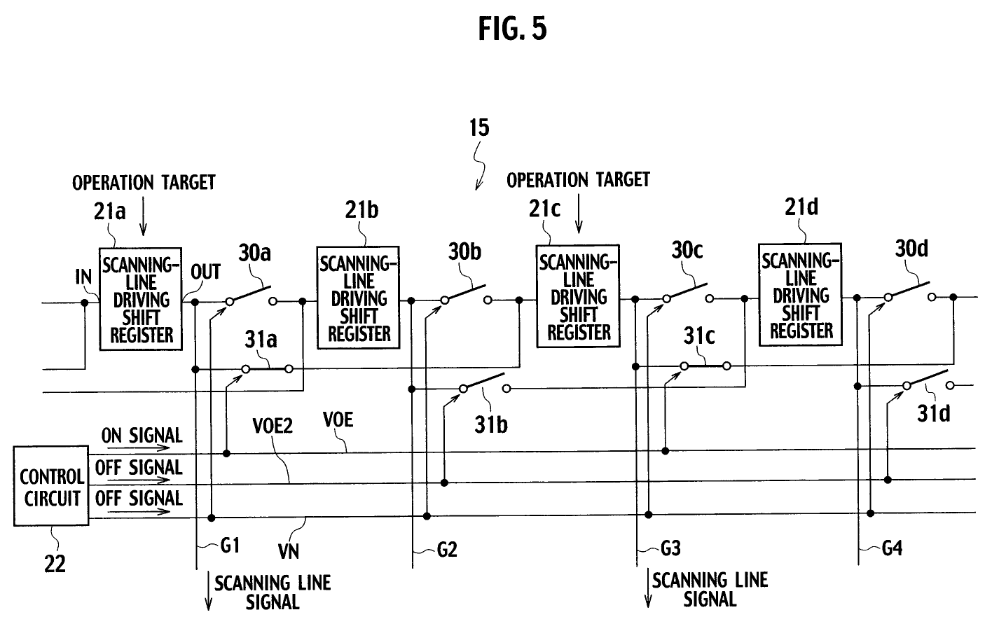

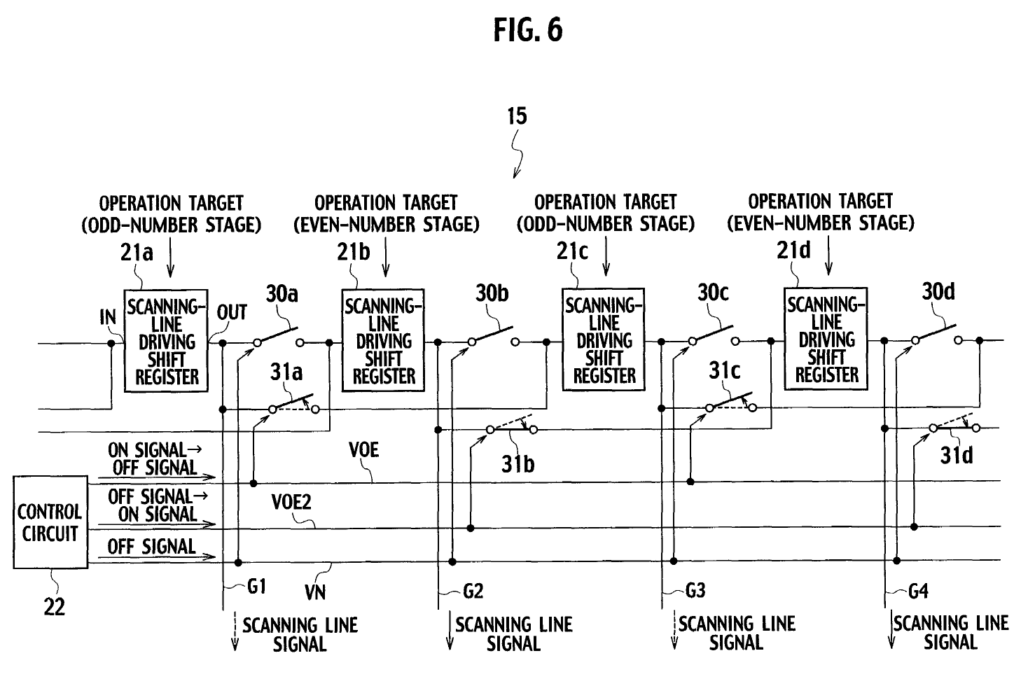

Next, by using FIG. 5, a description will be given of an operation of the MF drive in which every other scanning-line driving shift register is caused to be driven. The control circuit 22 transmits an ON signal to the control signal line VOE before the shift register start signal is transmitted to the scanning-line driving shift register 21a. As a result, the control circuit 22 turns ON the second switch elements 31a and 31c connected to the respective scanning-line driving shift registers 21a and 21c. Meanwhile, the control circuit 22 transmits OFF signals to the respective control signal lines VN and VOE2, and thereby the first switch elements 30a to 30d and the second switch elements 31b and 31d are set to be OFF.

Thereafter, the scanning-line driving shift register 21a receives the thus transmitted shift register start signal through the input terminal IN, and then outputs the shift register output signal through the output terminal OUT. The thus outputted shift register output signal is transmitted, as a scanning line signal, to the scanning line G1 connected to the output terminal OUT, and is also transmitted to the scanning-line driving shift register 21c corresponding to every other shift register (N+1 stages behind) via the second switch element 31a which has been set to be ON. Incidentally, since the first switch element 30a has been set to be OFF, the shift register output signal outputted from the scanning-line driving shift register 21a is not transmitted to the following scanning-line driving shift register 21b.

Then, the scanning-line driving shift register 21c receives, as an input signal, the shift register output signal transmitted from the scanning-line driving shift register 21a through the input terminal IN, and then outputs a shift register output signal through the output terminal OUT. The thus outputted shift register output signal is transmitted, as a scanning line signal, to the scanning line G3 connected to the output terminal OUT, and is also transmitted to the scanning-line driving shift register 21e (not shown) corresponding to every other shift register via the second switch element 31c which has been set to be ON. Incidentally, since the first switch element 30c has been set to be OFF, the shift register output signal outputted from the scanning-line driving shift register 21c is not transmitted to the following scanning-line driving shift register 21d.

Accordingly, the scanning-line driving circuit 15 sequentially transmits the shift register start signal or the shift register output signal to the scanning-line driving shift registers in the order of 21a, 21c, 21e, 21g . . . , and sequentially outputs the scanning line signal to the scanning lines in the order of G1, G3, G5, G7 . . . Consequently, the scanning-line driving circuit 15 achieves the MF drive in which every other scanning-line driving shift register is caused to be driven.

The description has been given of the operations of the MF drive for every other stage. Alternatively, the MF drive at every two stages (N stages) or more can be achieved by connecting the second switch elements 31a to 31d to the output terminals OUT of the respective scanning-line driving shift registers 21a to 21d, and to the input terminals IN of the scanning-line driving shift registers which are disposed three stages or more behind (N+1 stages where N=2). And, the MF drive at every two or more stages can be achieved by newly adding switch elements which are connected to scanning-line driving shift registers corresponding to every two or more stages, and then by controlling ON and OFF states of the newly-added switch elements by using the controlling circuit 22, instead of changing a scanning-line driving shift register to be connected.

In the MF drive at every other stage in the present embodiment, the first switch elements 30a and 30c connected to the respective scanning-line driving shift registers 21a and 21c, which are operation targets, are controlled to be OFF, and the second switch elements 31a and 31c connected to the output terminals of the first switch elements 30a and 30c are controlled to be ON. As a result, the shift register start signal or the shift register output signal is prevented from being transmitted to the scanning-line driving shift registers 21b and 21d which are not operation targets, and thereby power consumption can be reduced.

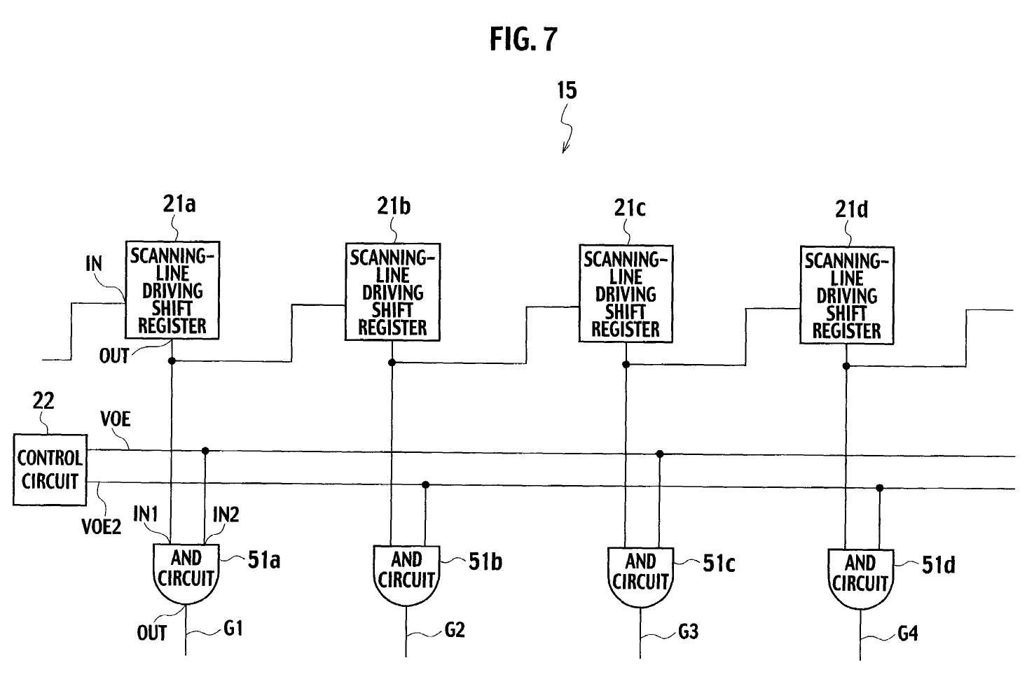

In the present embodiment, the scanning-line driving shift registers 21b and 21d, which are not operation targets, do not operate. Thus, in a scanning line drive circuit (refer to FIG. 7) of a comparative example to be described later, time spent for driving the scanning-line driving shift registers 21b and 21d which are connected to the respective scanning lines G2 and G4, and which are not operation targets, can be used for driving the scanning-line driving shift registers 21a and 21c which are operation targets. Accordingly, it is made possible to secure more time during which voltages are written to the scanning lines G1 and G3, and thereby it is possible to supply a voltage which has an electric potential closer to the desired potential.

And, in the present embodiment, the MF drive is achieved by controlling ON and OFF states of the first switch elements 30a to 30d and of the second switch elements 31a to 31d. Thus, even in a case of performing the MF drive at every Nstages, it is not necessary to add a logic circuit, and thereby it is possible to achieve the MF drive using a simple configuration of the scanning-line driving circuit 15.

Next, a description will be given of an operation of the MF drive in which scanning-line driving shift registers corresponding to even-number stages and odd-number stages are caused to be driven. A description will be given below while the scanning-line driving shift registers 21a and 21c are supposed to correspond to the odd-number stages, and the scanning-line driving shift registers 21b and 21d are supposed to correspond to even-number stages.

As in the case of the above-described operation of the MF drive at every other stage, the scanning-line driving circuit 15 sequentially transmits the shift register start signal or the shift register output signal to the scanning-line driving shift registers in the order of 21a, 21c, 21e, 21g . . . , and then sequentially outputs the scanning line signal to the scanning lines in the order of G1, G3, G5, G7 . . . Consequently, the scanning-line driving circuit 15 achieves the MF drive for the odd-number stages.

Subsequently, the control circuit 22 changes the ON signal which has been transmitted to the control signal line VOE to an OFF signal, and thereby turns OFF the second switch elements 31a and 31c connected to the output terminals OUT of the scanning-line driving shift register 21a and 21c corresponding to the odd-number stages. And, the control circuit 22 changes the OFF signal which has been transmitted to the control signal line VOE2 to an ON signal, and thereby turns ON the second switch elements 31b and 31d connected to the output terminals OUT of the scanning-line driving shift register 21b and 21d corresponding to the even-number stages. The control circuit 22 continues to transmit an OFF signal to the control signal line VN, while retaining the set OFF state of the first switch elements 30a to 30d.

Thereafter, the scanning-line driving shift register 21b receives the transmitted shift register start signal from the input terminal IN, and then outputs a shift register output signal through the output terminal OUT. The thus outputted shift register output signal is transmitted, as a scanning line signal, to the scanning line G2 connected to the output terminal OUT, and is also transmitted to the scanning-line driving shift register 21d via the second switch element 31b which has been set to be ON.

Then, the scanning-line driving shift register 21d receives as an input signal, the shift register output signal transmitted from the scanning-line driving shift register 21b through the input terminal IN, and then outputs a shift register output signal through the output terminal OUT. The thus outputted shift register output signal is transmitted, as a scanning line signal, to the scanning line G4 connected to the output terminal OUT, and is also transmitted to a scanning-line driving shift register 21f (not shown) via the second switch element 31d which has been set to be ON.

Accordingly, the scanning-line driving circuit 15 sequentially transmits the shift register start signal or the shift register output signal to the scanning-line driving shift registers in the order of 21b, 21d, 21f, 21h . . . , and then sequentially outputs the scanning line signal sequentially to the scanning lines in the order of G2, G4, G6, G8 . . . As a result, the scanning-line driving circuit 15 achieves the MF drive for the even-number stages.

It is supposed that, in the MF drive of the present embodiment in which the scanning-line driving shift registers corresponding to the odd- and even-number stages are caused to be driven, the scanning-line driving shift register 21a and 21c corresponding to the odd-number stages are operated. In this case, the first switch elements 30a and 30c connected to the output terminals of the scanning-line driving shift register 21a and 21c corresponding to the odd-number stages are controlled to be OFF, while the second switch elements 31a and 31c connected to the output terminals are controlled to be ON. When operating the scanning-line driving shift registers 21b and 21d corresponding to the even-number stages, the first switch elements 30b and 30d connected to the output terminals of the scanning-line driving shift registers 21b and 21d corresponding to the even numbers are controlled to be OFF, while the second switch elements 31b and 31d connected to the output terminals are controlled to be ON. Thus, the present embodiment makes it possible to easily perform the MF drive for the even- and odd-number stages by controlling the stitch elements.

The scanning-line driving circuit 15 of the present embodiment makes it possible to achieve the normal drive and the MF drive with the same circuit.

FIG. 7 is a circuit configuration showing a configuration diagram of a scanning line drive circuit which is a comparative example for the present embodiment. A scanning-line driving circuit 15 illustrated in FIG. 7 includes a plurality of scanning-line driving shift registers 21a to 21d; a plurality of AND circuits 51a to 51d; a control signal line VOE connected to input terminals IN2 of the respective AND circuits 51a and 51c; a control signal line VOE2 connected to input terminals IN2 of the respective AND circuits 51b and 51d; scanning lines GI to G4 connected to output terminals OUT of the respective AND circuits 51a to 51d; and a control circuit 22 connected to the control signal lines VOE and VOE2.

Input terminals IN of the respective scanning-line driving shift registers 21a to 21d are connected to the output terminals OUT of the preceding scanning-line driving shift registers. Input terminals IN1 of the respective AND circuits 51a to 51d are connected to the output terminals OUT of the respective scanning-line driving shift registers 21a to 21d corresponding thereto.

The normal drive of a comparative example will be described. The control circuit 22 continues to supply an ON signal to the control signal lines VOE and VOE2 before a shift register start signal is transmitted to the scanning-line driving shift register 21a. The ON signal is transmitted to the input terminals IN2 of the respective AND circuits 51a to 51d connected to the control signal lines VOE and VOE2, and thereby input logical values on certain sides of the respective AND circuits 51a to 51d are set to be 1 (ON). Thereafter, the scanning-line driving shift register 21a receives the transmitted shift register start signal through the input terminal IN, and then outputs a shift register output signal, through the output terminal OUT, to the AND circuit 51a and to the scanning-line driving shift register 21b corresponding to the following stage. The AND circuit 51a receives the shift register output signal through the input terminal IN1, and then sets an input logical value on a different side of the AND circuit 51a to be 1 (ON). Since the input logical values of the two input terminals IN1 and IN2 of the AND circuit 51a are 1 (ON), the AND circuit 51a outputs a scanning line signal to the scanning line G1 through the output terminal OUT on the basis of the characteristics of the AND circuit.

Then, the scanning-line driving shift registers 21b to 21d disposed subsequent to the scanning-line driving shift register 21a respectively receive, as input signals, shift register output signals transmitted from the scanning-line driving shift registers 21a to 21c corresponding to the respective preceding stages, through the respective input terminals IN. Scanning line signals are outputted to the scanning lines G2 to G4 through the output terminals OUT of the respective AND circuits 51b to 51d by repeating the same operation as that described above.

Accordingly, the scanning-line driving circuit 15 sequentially transmits the shift register start signal or the shift register output signal to the scanning-line driving shift registers in the order of 21a, 21b, 21c, 21d, and then sequentially outputs the scanning line signal sequentially to the scanning lines in the order of G1, G2, G3, G4. Thereby, the normal drive is achieved.

Next, a description will be given of the MF drive in which the scanning lines (scanning lines G1 and G3) corresponding to the odd-number stages in the comparative example are caused to be driven. The control circuit 22 continues to supply an ON signal to the control signal line VOE before a shift register start signal is transmitted to the scanning-line driving shift register 21a. The ON signal is transmitted to the input terminals IN2 of the respective AND circuits 51a and 51c connected to the control signal line VOE, and thereby input logical values on certain sides of the respective AND circuits 51a and 51c are set to be 1 (ON). Meanwhile, an OFF signal continues to be supplied to the control signal line VOE2, and thereby input logical values on the certain sides of the respective AND circuits 51b and 51d connected to the control signal line VOE2 are set to be 0 (OFF). Thereafter, the scanning-line driving shift register 21a receives the transmitted shift register start signal through the input terminal IN, and then outputs a shift register output signal, through the output terminal OUT, to the AND circuit 51a and to the scanning-line driving shift register 21b corresponding to the following stage. The AND circuit 51a receives the shift register output signal through the input terminal IN1, and then sets an input logical value on a different side of the AND circuit 51a to be 1 (ON). Since the input logical values of the two input terminals IN1 and IN2 of the AND circuit 51a are 1 (ON), the AND circuit 51a outputs a scanning line signal to the scanning line G1 through the output terminal OUT on the basis of the characteristics of the AND circuit.

The scanning-line driving shift register 21b receives, as an input signal, the shift register start signal transmitted from the scanning-line driving shift register 21a, through the input terminal IN, and then outputs a shift register output signal through the output terminal OUT, to the AND circuit 51b and to the scanning-line driving shift register 21c corresponding to the following stage. The AND circuit 51b receives the shift register output signal through the input terminal IN1, and then sets an input logical value on a different side of the AND circuit 51b to be 1 (ON). Since the input logical values of the input terminals IN1 and IN2 of the AND circuit 51b are 1 (ON) and 0 (OFF), respectively, the AND circuit 51b does not output a scanning line signal to the scanning line G2 through the output terminal OUT on the basis of the characteristics of the AND circuit. Incidentally, operations of the scanning-line driving shift registers 21c and 21d connected subsequent to the scanning-line driving shift register 21b, and operations of the AND circuits 51c and 51d are the same as those described above, so that description is omitted.

Accordingly, the scanning-line driving circuit 15 sequentially transmits the shift register start signal or the shift register output signal to the scanning-line driving shift registers in the order of 21a, 21b, 21c, 21d, and then sequentially outputs the scanning line signal sequentially to the scanning lines in the order of G1 and G3. Thereby, the MF drive for the odd-number stages is realized.

Subsequently, a description will be given of the MF drive in which the scanning lines (scanning lines G2 and G4) corresponding to the even-number stages in the comparative example are caused to be driven. The control circuit 22 continues to supply an OFF signal to the control signal line VOE, and continues to supply an ON signal to the control signal line VOE2. Thereby, the MF drive for the even stages is made possible. Specific operations are the same as those of the MF drive for the odd-number stages, and thus the description thereof is omitted.

In the case of the MF drive of the comparative example, since the scanning-line driving shift register, which is not an operation target, is also driven, the consumed power and time for driving the scanning line drive shift register, which is not an operation target, are wasted. Since scanning-line driving shift registers of the comparative example are connected to scanning-line driving shift registers corresponding to the preceding stages, an additional logical circuit is required in a case where the MF drive at every two or more stages is performed. Consequently, the configuration of the scanning line drive circuit becomes complicated, and an area occupied bv the scanning line drive circuit on a substrate of a display device is increased. In other words, as compared with the scanning-line driving circuit of the present invention, the scanning line drive circuit of the comparative example requires more power consumption and more driving time, and the configuration of the circuit is more complicated.

### Second Embodiment

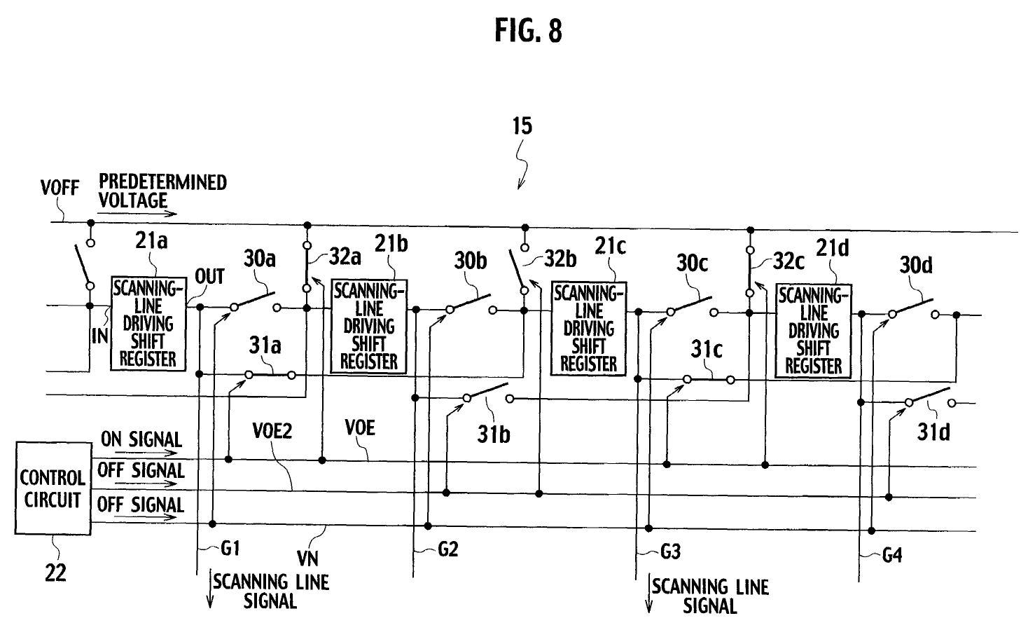

FIG. 8 is a circuit diagram showing a configuration of a scanning-line driving circuit 15 of a second embodiment. In addition to the configuration of the first embodiment, the scanning-line driving circuit 15 of the second embodiment further includes a signal line VOFF to which a predetermined electric signal is transmitted, and third switch elements 32a to 32c. The third switch elements 32a to 32c are respectively connected to the signal line VOFF, and input terminals IN respectively of scanning-line driving shift registers 21b to 21d. The third switch elements 32a and 32c corresponding to every other switch element are connected to the control signal line VOE, and the third switch elements 32b and 32d (not shown) corresponding to every other switch element are connected to the control signal line VOE2. The other configuration is the same as the configuration of the first embodiment, and thus the description thereof will be omitted.

The signal line VOFF and the third switch elements 32a to 32c operate as a floating prevention circuit provided with a function which prevents floating of the input terminals of the respective scanning-line driving shift registers 21b to 21d. The floating is defined as a state where an electric instability occurs due to the absence of an input signal on an input terminals of a scanning-line driving shift registers. Due to this floating state, a voltage may be erroneously supplied to a connected scanning line, and thereby picture quality may possibly be deteriorated.

To the signal line VOFF, for example, a constant voltage such as 0 volt (zero voltage) is continuously supplied. The third switch elements 32a to 32c are configured, for example, of a PMOS, an NMOS, a CMOS and the like.

Next, a description will be given of an operation of the scanning-line driving circuit 15 of the present embodiment. The control circuit 22 transmits an ON signal to the control signal line VOE before a shift register start signal is transmitted to the scanning-line driving shift register 21a; turns on the second switch elements 31a and 31c connected to the output terminals OUT of the scanning-line driving shift registers 21a and 21c, which are operation targets; and also turns on the third switch elements 32a and 32c connected to the input terminals IN of the scanning-line driving shift registers 21b and 21d which are not operation targets. As a result, predetermined electric signals are given from the signal line VOFF to the scanning-line driving shift registers 21b and 21d, which are not operation targets, and thereby floating of the input terminal IN can be prevented. Meanwhile, an OFF signal is transmitted to the control signal lines VN and VOE2, and thereby the first switch elements 30a to 30d and the second switch elements 31b and 31d are set to be OFF.

Thereafter, the scanning-line driving shift register 21a receives the transmitted shift register start signal through the input terminal IN, and then outputs a shift register output signal to the output terminal OUT. The thus outputted shift register output signal is transmitted, as a scanning line signal, to the scanning line G1 connected to the output terminal OUT, and is also transmitted to the scanning-line driving shift register 21c via the second switch element 31a which has been set to be ON. In addition, since the first switch element 30a has been set to be OFF, the shift register output signal outputted from the scanning-line driving shift register 21a is not transmitted to the scanning-line driving shift register 21b.

Thereafter, the scanning-line driving shift register 21c receives, as an input signal, the shift register output signal transmitted from the scanning-line driving shift register 21a, through the input terminal IN, and then outputs a shift register output signal through the output terminal OUT. The thus outputted shift register output signal is transmitted to the scanning line G3 connected to the output terminal OUT, and is also transmitted to a scanning-line driving shift register 21e (not shown) via the second switch element 31c which has been set to be ON. Incidentally, since the first switch element 30c has been set to be OFF, the shift register output signal outputted from the scanning-line driving shift register 21c is not transmitted to the scanning-line driving shift register 21d.

Accordingly, the scanning-line driving circuit 15 sequentially transmits the shift register start signal or the shift register output signal to the scanning-line driving shift registers in the order of 21a, 21c, 21e, 21g, . . . , and then sequentially outputs the scanning line signal sequentially to the scanning lines in the order of G1, G3, G5, G7, . . . As a result, the scanning-line driving circuit 15 achieves the MF drive for the driving at every other stage.

Also in the present embodiment, as in the case of the first embodiment, the control circuit 22 switches between an ON signal and an OFF signal, to be supplied to the control signal lines VN, VOE and VOE2. Thereby, it is possible to easily achieve the normal drive, the MF drive at every two or more stages, or the MF stage at the odd-number stages and the even-number stages.

In the present embodiment, predetermined electric signals transmitted from the signal line VOFF are given to the input terminals of the scanning-line driving shift registers 21b and 21d, which are not operation targets, via the third switch elements 32a and 32c connected to the signal line VOFF and to the input terminals of the scanning-line driving shift registers 21b and 21d which are not operation target. Thus, it is possible to prevent erroneous operations of the scanning-line driving shift registers 21b and 21d which are not operation targets, and thereby to prevent picture quality from being deteriorated, with the stable operation of the scanning-line driving circuit 15. That is, in the present embodiment, the present invention makes it possible to achieve MF drive which performs stable and high-quality operations.

A description has been given of the scanning-line driving circuit 15 in the first and second embodiments applied to a scanning line drive circuit used for a liquid crystal display device of an active matrix type. However, the present invention is not limited to the display device using liquid crystals. For example, instead of liquid crystals, organic EL or the like may be applied to the display device.

What is claimed is:

1. A scanning line drive circuit for a display device, comprising:
scanning-line driving shift registers which are serially disposed at a plurality of stages, and each of which outputs a scanning line signal to a corresponding scanning line connected to an output terminal, in response to a signal inputted through an input terminal;
first switch elements each connected between the output terminal of a first one of the scanning-line driving shift registers and the input terminal of a second scanning-line driving shift register disposed at a stage following the first scanning-line driving shift register;
second switch elements each connected between the output terminal of a first one of the scanning-line driving shift registers and the input terminal of a third scanning-line driving shift register disposed at the N+1-th stage following the current scanning-line driving shift register (N being a positive integer equal to or greater than 1); and
a control circuit which controls the first switch elements and the second switch elements.

2. The scanning line drive circuit for a display device according to claim 1, wherein,
when operating the scanning-line driving shift registers corresponding to the odd-number stages, the control circuit makes a control so that the first switch elements each connected to the output terminal of one of the scanning-line driving shift registers corresponding to the odd-number stages would be off, and that the second switch elements each connected to the output terminal would be on, and
when operating scanning-line driving shift registers corresponding to the even-number stages, the control circuit makes a control so that the first switch elements each connected to the output terminal of one of the scanning-line driving shift registers corresponding to the odd-number stages would be off, and that the second switch elements each connected to the output terminal would be on.

3. A scanning-line driving circuit for a display device comprising:
scanning-line driving shift registers which are serially disposed on a plurality of stages, and each of which outputs a scanning line signal to a corresponding scanning line connected to an output terminal, in response to a signal inputted through an input terminal;
first switch elements each connected between the output terminal of a first one of the scanning-line driving shift registers and an input terminal of a second scanning-line driving shift register disposed at a stage following the current scanning-line driving shift register;
second switch elements each connected between the output terminal of a first one of the scanning-line driving shift registers and the input terminal of a second scanning-line driving shift register disposed at the N+1-th stage following the current scanning-line driving shift register (N being a positive integer equal to or greater than 1);
a signal line through which a predetermined electric signal is transmitted;
third switch elements each connected to the signal line and to the input terminal of a corresponding one of the scanning-line driving shift registers; and
a control circuit which controls the first switch elements, the second switch elements and the third switch elements.
